(19) United States
(12) Patent Application Publication
(10) Pub. No.: US 2026/0236416 A1
(43) Pub. Date: Aug. 13, 2026

(54) DATA TRANSMISSION METHOD, DEVICE, CHIPLET, READABLE STORAGE MEDIUM, AND PROGRAM PRODUCT

(71) Applicant: Black Sesame Technologies Co., Ltd., Wuhan (CN)

(72) Inventor: Limin Cao, Shenzhen (CN)

(73) Assignee: Black Sesame Technologies Co., Ltd., Wuhan (CN)

(21) Appl. No.: 19/455,413

(22) Filed: Jan. 21, 2026

(30) Foreign Application Priority Data
Feb. 8, 2025 (CN) 2025101422850

(51) Int. Cl. G06F 13/36

(52) U.S. Cl. CPC G06F 13/36; G06F 2213/0064

(57) ABSTRACT

The present application relates to a data transmission method, device, chiplet, computer-readable storage medium, and computer program product. The method includes: receiving a first data from the coherent interconnection bus via a first receiver, the first receiver being compatible with an external interface of the coherent interconnection bus; performing first conversion on the first data, and sending the converted first data to the DTD module via a first transmitter, the first transmitter being compatible with an external interface of the DTD module; receiving a second data from the DTD module via a second receiver, the second receiver being compatible with an external interface of the DTD module; and performing second conversion on the second data, and sending the converted second data to the coherent interconnection bus via a second transmitter, the second transmitter being compatible with an external interface of the coherent interconnection bus.

### RELATED APPLICATION

This application claims the benefit under 35 U.S.C. § 119(a) of the filing date of Chinese Patent Application No. 2025101422850, filed in the Chinese Patent Office on Feb. 8, 2025. The disclosure of the foregoing application is herein incorporated by reference in its entirety.

### TECHNICAL FIELD

The present application relates to a field of chip technology, and in particular to a data transmission method, device, chiplet, computer-readable storage medium, and computer program product.

### BACKGROUND

In the field of chip manufacturing, in order to enhance chip computing power, as well as to improve chip yield and reduce costs, a large chip is often split into multiple smaller chips (also known as Chiplets) during chip design. The coherent interconnection bus on the chiplet cannot usually be directly interconnected. A Die To Die (DTD) module (also known as chiplet interconnect module) is required to achieve off-chiplet interconnection between two chiplets.

In practical applications, although the adoption of DTD module can solve the problem of off-chiplet interconnection between chiplets, due to the iterative development of the product, there may be a situation where the external interface of the DTD module and the external interface of the coherent interconnection bus of the chiplet are incompatible. This may cause data loss and system malfunction when directly connecting the DTD module and the coherent interconnection bus of the chiplet, resulting in data transmission failure.

### SUMMARY

Therefore, in view of the above-mentioned technical problems, it is necessary to provide a data transmission method, device, chiplet, computer-readable storage medium, and computer program product that can reduce chiplet data transmission failures.

In a first aspect, the present application provides a data transmission method applied to a data transmission device of a chiplet, wherein the chiplet is further equipped with a coherent interconnection bus and a DTD (Die to Die) module, and the method comprises:
receiving a first data from the coherent interconnection bus via a first receiver, the first receiver being compatible with an external interface of the coherent interconnection bus;
performing first conversion on the first data, and sending the converted first data to the DTD module via a first transmitter, the first transmitter being compatible with an external interface of the DTD module;
receiving a second data from the DTD module via a second receiver, the second receiver being compatible with an external interface of the DTD module; and
performing second conversion on the second data, and sending the converted second data to the coherent interconnection bus via a second transmitter, the second transmitter being compatible with an external interface of the coherent interconnection bus.

In one embodiment, performing the first conversion on the first data comprises: performing cross-clock domain processing on the first data and then performing format conversion; and performing the second conversion on the second data comprises: performing format conversion on the second data and then performing cross-clock domain processing; or performing the first conversion on the first data comprises: performing format conversion on the first data and then performing cross-clock domain processing; performing second conversion on the second data comprises: performing cross-clock domain processing on the second data and then performing format conversion.

In one embodiment, the format conversion comprises at least one of protocol conversion or bit width conversion; the protocol conversion comprises at least one of adding a preset frame header or removing a preset frame header; and the bit width conversion comprises at least one of data splicing or data splitting.

In one embodiment, the method further comprises: establishing a first link between the DTD module and the coherent interconnection bus, the first link being used for the transmission of the second data; and establishing a second link between the coherent interconnection bus and the DTD module, the second link being used for the transmission of the first data.

In one embodiment, establishing the first link between the DTD module and the coherent interconnection bus comprises:
synchronizing, in response to a first request signal from the DTD module being in a high-level state, the first request signal that is in the high-level state;
setting a second request signal to the high-level state once the synchronization is done, the second request signal in the high-level state being used to instruct the coherent interconnection bus to set a first acknowledgment signal to the high-level state;
synchronizing, in response to the first acknowledgment signal from the coherent interconnection bus being in the high-level state, the first acknowledgment signal that is in the high-level state; and
setting a second acknowledgment signal to the high-level state once the synchronization is done, so as to accomplish an establishment of the first link.

In one embodiment, establishing the second link between the coherent interconnection bus and the DTD module comprises:
synchronizing, in response to a third request signal from the coherent interconnection bus being in a high-level state, the third request signal that is in the high-level state;
setting a fourth request signal to the high-level state once the synchronization is done and a link establishment request is received from the DTD module, the fourth request signal in the high-level state being used to instruct the DTD module to set a third acknowledgment signal to the high-level state;
synchronizing, in response to the third acknowledgment signal from the DTD module being in the high-level state, the third acknowledgment signal that is in the high-level state; and
setting a fourth acknowledgment signal to the high-level state once the synchronization is done, so as to accomplish an establishment of the second link.

In one embodiment, the method further comprises: disconnecting a first link between the DTD module and the coherent interconnection bus, the first link being the link used during the transmission of the second data; and disconnecting a second link between the coherent interconnection bus and the DTD module, the second link being the link used during the transmission of the first data.

In one embodiment, disconnecting the first link between the DTD module and the coherent interconnection bus comprises:
synchronizing, in response to a first request signal from the DTD module being in a low-level state, the first request signal that is in the low-level state;
setting a second request signal to the low-level state once the synchronization is done, the second request signal in the low-level state being used to instruct the coherent interconnection bus to set a first acknowledgment signal to the low-level state;
synchronizing, in response to the first acknowledgment signal from the coherent interconnection bus being in the low-level state, the first acknowledgment signal that is in the low-level state; and
setting a second acknowledgment signal to the low-level state once the synchronization is done, so as to disconnect the first link.

In one embodiment, disconnecting the second link between the coherent interconnection bus and the DTD module comprises:
setting a hint signal to a high-level state, the hint signal in the high-level state being used to instruct the coherent interconnection bus to set a third request signal to a low-level state;
synchronizing, in response to the third request signal from the coherent interconnection bus being in the low-level state, the third request signal that is in the low-level state;
setting a fourth request signal to the low-level state once the synchronization is done and a link disconnection request is received from the DTD module, the fourth request signal in the low-level state being used to instruct the DTD module to set a third acknowledgment signal to the low-level state;
synchronizing, in response to the third acknowledgment signal from the DTD module being in the low-level state, the third acknowledgment signal that is in the low-level state; and
setting a fourth acknowledgment signal to the low-level state once the synchronization is done, so as to disconnect the second link.

In a second aspect, the present application also provides a data transmission device, comprising:
a first receiver, compatible with an external interface of a coherent interconnection bus of a chiplet and configured to receive a first data from the coherent interconnection bus;
a first conversion module, connected to the first receiver and configured to perform first conversion on the first data received by the first receiver;
a first transmitter, connected to the first conversion module and compatible with an external interface of a Die to Die (DTD) module and configured to send the converted first data to the DTD module;
a second receiver, compatible with an external interface of the DTD module and configured to receive a second data from the DTD module;
a second conversion module, connected to the second receiver and configured to perform second conversion on the second data received by the second receiver; and
a second transmitter, connected to the second conversion module and compatible with an external interface of the coherent interconnection bus and configured to send the converted second data to the coherent interconnection bus.

In one embodiment, the first conversion module comprises a first format conversion unit and a first synchronization unit, the first format conversion unit is configured to perform format conversion on the first data, and the first synchronization unit is configured to perform cross-clock domain processing on the first data; and the second conversion module comprises a second format conversion unit and a second synchronization unit, the second format conversion unit is configured to perform format conversion on the second data, and the second synchronization unit is configured to perform cross-clock domain processing on the second data.

In one embodiment, the device further comprises an extraction module, and the extraction module is connected to the second receiver and the first transmitter respectively and configured to identify whether a data signal sent by the DTD module comprises a link establishment request or a link disconnection request.

In a third aspect, the present application also provides a chiplet, comprising a coherent interconnection bus, a data transmission device, a Die to Die (DTD) module, a memory, and a processor, wherein the memory stores a computer program, when executed by the processor, implementing the steps of the above-described data transmission method.

In a fourth aspect, the present application also provides a computer-readable storage medium having a computer program stored thereon, wherein the computer program, when executed by a processor, implements the steps of the above-described data transmission method.

In a fifth aspect, the present application also provides a computer program product comprising a computer program, wherein the computer program, when executed by a processor, implements the steps of the above-described data transmission method.

According to the aforementioned data transmission method, device, chiplet, computer-readable storage medium, and computer program product, an asynchronous interface connection between the coherent interconnection bus of the chiplet and the DTD module is achieved through a set of interfaces (i.e., the first receiver and the second transmitter) adapted for connection with the coherent interconnection bus of the chiplet, and a set of interfaces (i.e., the first transmitter and the second receiver) adapted for connection with the DTD module, so that data can be normally sent and received. Furthermore, data can be correctly transmitted by means of data conversion in a transmission process, thereby ensuring the normal operation of a chip system.

### BRIEF DESCRIPTION OF THE DRAWINGS

In order to illustrate the embodiments of the present disclosure more clearly, the drawings used in the embodiments or in the description of related technologies will be described briefly. Apparently, the following described drawings are merely for the embodiments of the p resent disclosure, and other drawings can be derived by those of ordinary skill in the art without any creative effort.

FIG. 1 is an application environment diagram of a data transmission method according to an embodiment;

FIG. 2 is a structural block diagram of a data transmission device according to an embodiment;

FIG. 3 is a structural block diagram of a data transmission device according to another embodiment;

FIG. 4 is a structural block diagram of the data transmission device according to yet another embodiment;

FIG. 5 is a communication architecture diagram of a DTD module and a coherent interconnection bus according to an embodiment;

FIG. 6 is a flowchart illustrating a data transmission method according to an embodiment;

FIG. 7 is a schematic diagram of a link establishment process according to an embodiment;

FIG. 8 is a schematic diagram of a link disconnection process according to an embodiment.

Explanation of reference numerals in the drawings:
10—chiplet, 12—coherent interconnection bus, 14—DTD module, 16—data transmission device, 161—a first receiver, 162—a first conversion module, 163—a first transmitter, 164—a second receiver, 165—a second conversion module, 166—a second transmitter, 167—extraction module, 1621—a first format conversion unit, 1622—a first synchronization unit, 1651—a second format conversion unit, 1652—a second synchronization unit.

### DETAILED DESCRIPTION

The present disclosure will now be described in detail with reference to the accompanying drawings and embodiments in order to make the objects, technical solutions, and advantages of the present disclosure more clear. It should be understood that the specific embodiments described herein are only for explaining the present disclosure, and not intended to limit the present disclosure.

It should be noted that the terms “first”, “second” etc., mentioned in the present application may be used to describe various elements, but these elements are not limited by these terms. These terms are used only to distinguish the first element from another element, not to specify the order. For example, the first receiver may be referred to as the second receiver, and similarly, the first transmitter may be referred to as the second transmitter, etc. without departing from the scope of the present application.

In the field of chip manufacturing, in order to enhance chip computing power, as well as to improve chip yield and reduce costs, a large chip is often split into multiple chiplets during chip design. Interconnection between different chiplets usually needs to be achieved by using a Die To Die (DTD or D2D) module, so as to implement communication between chiplets. In practical applications, there may be a situation where the external interface of the DTD module and the external interface of the coherent interconnection bus (CMN, also known as coherent interconnection network or coherent mesh network) are incompatible. For example, the external interface of the DTD module and the external interface of the coherent interconnection bus may respectively correspond to different interface protocols or different versions of the same interface protocol, which may result in unsuccessful connection (and thus unsuccessful direct communication) between the DTD module and the coherent interconnection bus. For example, in some cases, the external interface of the DTD module is the CXS.B interface, while the external interface of the coherent interconnection bus of the chiplet, such as the CMN600AE, is the CXS.A interface. If the CMN600AE and the DTD module are directly connected, it may result in the issues such as data not being recognized, as well as data loss and system malfunction. CXS refers to Credited eXtensible Stream, which is a streaming interface protocol for point-to-point packetized communication, and CXS.A is version A of the streaming interface protocol, and CXS.B is version B of the streaming interface protocol.

In view of this, embodiments of the present application provide a data transmission method, which enables asynchronous interface connection between the coherent interconnection bus of the chiplet and the DTD module through a set of interfaces adapted for connection with the coherent interconnection bus of the chiplet, and a set of interfaces adapted for connection with the DTD module, thereby allowing data to be normally sent and received. Furthermore, data can be correctly transmitted by means of data conversion in a transmission process, thereby ensuring the normal operation of a chip system.

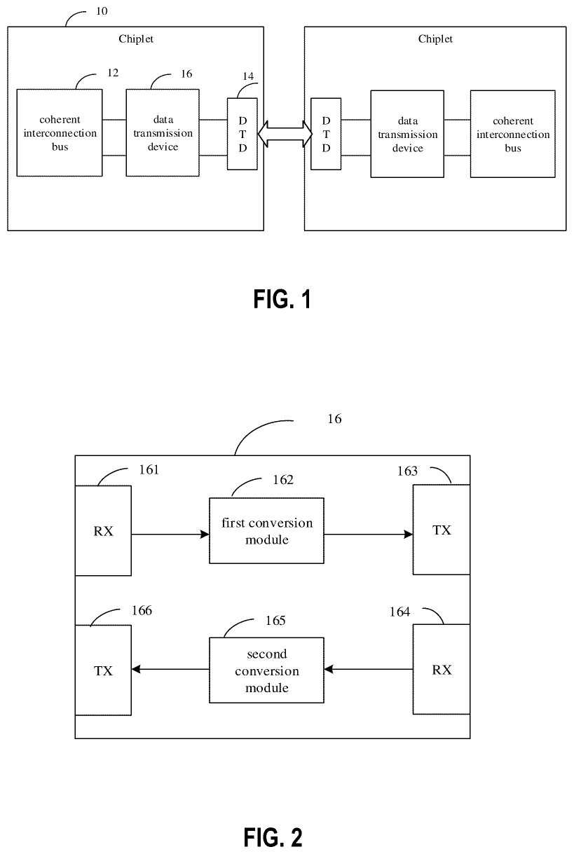

Before providing a detailed description of the data transmission device and data transmission method provided in the present application, the application environment in which the data transmission device and data transmission method are applied will be explained first. In an exemplary embodiment, the data transmission device and/or method can be applied to the application environment shown in FIG. 1. The following explanation uses a single chiplet as an example. The chiplet 10 is equipped with a coherent interconnection bus 12 and a DTD module (also known as chiplet interconnect module) 14. Normal communication (data transmission) between the coherent interconnection bus 12 and the DTD module 14 can be achieved through the data transmission device 16. The DTD module 14 deployed on the chiplet 10 can transmit data with the DTD module deployed on other chiplets to achieve communication interconnection between different chiplets. The structure of other chiplets may be the same as or different from that of chiplet 10, and there is no limitation in the embodiments of the present application. It should be noted that the data transmission device 16 in the present application can be implemented by an asynchronous bridge, which can also be deployed on the chiplet 10. In some embodiments, the asynchronous bridge may specifically be an asynchronous bridge based on the streaming interface protocol (CXS bridge).

In an exemplary embodiment, as shown in FIG. 2, the data transmission device 16 includes: a first receiver 161, compatible with an external interface of a coherent interconnection bus 12 and configured to receive a first data from the coherent interconnection bus 12; a first conversion module 162, connected to the first receiver 161 and configured to perform first conversion on the first data received by the first receiver 161; a first transmitter 163, connected to the first conversion module 162 and compatible with an external interface of a DTD module 14 and configured to send the converted first data to the DTD module 14; a second receiver 164, compatible with an external interface of the DTD module 14 and configured to receive a second data from the DTD module 14; a second conversion module 165, connected to the second receiver 164 and configured to perform second conversion on the second data received by the second receiver 164; and a second transmitter 166, connected to the second conversion module 165 and compatible with an external interface of the coherent interconnection bus 12 and configured to send the converted second data to the coherent interconnection bus 12.

As mentioned above, in order to achieve data communication between different chiplets, data transmission is required between the coherent interconnection bus 12 and the DTD module 14 which are deployed on a single chiplet. Since the coherent interconnection bus 12 and the DTD module 14 may respectively correspond to different interface protocols or different versions of the same interface protocol, the coherent interconnection bus 12 and the DTD module 14 cannot be directly connected. For example, the external interface of DTD module is CXS.B interface, while the external interface of the coherent interconnection bus of the chiplet, such as CMN600AE, is CXS.A interface.

Therefore, the present application designs two sets of interfaces to connect to the DTD module 14 and the coherent interconnection bus 12 respectively. Each set of interfaces consists of a receiver (RX) and a transmitter (TX). Specifically, one set of interfaces consists of a second transmitter 166 and a first receiver 161, which are compatible with the interface protocol and protocol version corresponding to the external interface of the coherent interconnection bus 12, and are adapted for connection with the coherent interconnection bus 12; the other set of interfaces consists of a first transmitter 163 and a second receiver 164, which are compatible with the interface protocol and protocol version corresponding to the external interface of the DTD module 14, and are adapted for connection with the DTD module 14.

Specifically, the first receiver 161 can receive the first data from the coherent interconnection bus 12. The first conversion module 162, connected to the first receiver 161, performs first conversion on the first data to convert the first data into data that can be processed by the DTD module 14, and then, the first transmitter 163 sends the converted first data to the DTD module 14 to achieve the data transmission from the coherent interconnection bus 12 to the DTD module 14. It is understood that the first receiver 161 is compatible with the external interface of the coherent interconnection bus 12 (that is, corresponding to the same interface protocol and protocol version) so as to be able to successfully receive the first data from the coherent interconnection bus 12; and the first transmitter 163 is compatible with the external interface of the DTD module 14 (that is, corresponding to the same interface protocol and protocol version) so as to be able to successfully send the converted first data to the DTD module 14.

Similarly, in order to achieve data transmission from the DTD module 14 to the coherent interconnection bus 12 of the chiplet, the data transmission device 16 in the present application is also designed with a second receiver 164, a second conversion module 165 and a second transmitter 166. The second receiver 164 can receive the second data from the DTD module 14. The second conversion module 165 performs second conversion on the second data to convert the second data into data that can be processed by the coherent interconnection bus 12, and then the second transmitter 166 sends the converted second data to the coherent interconnection bus 12 to achieve the data transmission from the DTD module 14 to the coherent interconnection bus 12. It is understood that the second receiver 164 is compatible with the external interface of the DTD module 14 (that is, corresponding to the same interface protocol and protocol version) so as to be able to successfully receive the second data from the DTD module 14; and the second transmitter 166 is compatible with the external interface of the coherent interconnection bus 12 (that is, corresponding to the same interface protocol and protocol version) so as to be able to successfully send the converted second data to the coherent interconnection bus 12.

It should be noted that the first data transmitted by the coherent interconnection bus 12 of the chiplet can be instructions, calculation results, and intermediate cache data, etc. generated by that chiplet; and the second data transmitted by the DTD module 14 can specifically originate from other chiplet(s), such as instructions, calculation results, and intermediate cache data, etc. generated by other chiplet(s).

According to the aforementioned data transmission device, an asynchronous interface connection between the coherent interconnection bus of the chiplet and the DTD module is achieved through a set of interfaces adapted for connection with the coherent interconnection bus of the chiplet, and a set of interfaces adapted for connection with the DTD module, so that data can be normally sent and received. Furthermore, data can be correctly transmitted by means of data conversion in a transmission process, thereby ensuring the normal operation of a chip system.

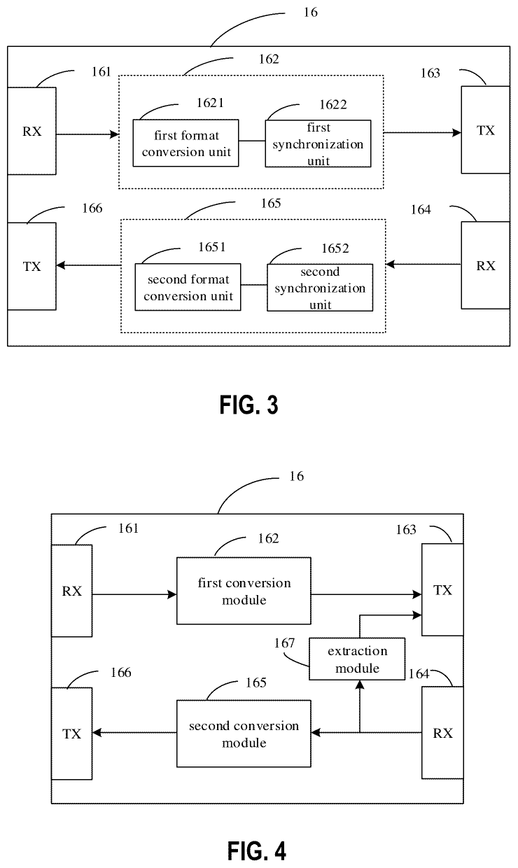

Referring to FIG. 3, in some embodiments, the first conversion module 162 includes a first format conversion unit 1621 and a first synchronization unit 1622. The first format conversion unit 1621 is configured to perform format conversion on the first data, and the first synchronization unit 1622 is configured to perform cross-clock domain processing on the first data. The second conversion module 165 includes a second format conversion unit 1651 and a second synchronization unit 1652. The second format conversion unit 1651 is configured to perform format conversion on the second data, and the second synchronization unit 1652 is configured to perform cross-clock domain processing on the second data.

It should be noted that the DTD module 14 and the coherent interconnection bus 12 of the chiplet are usually driven by different clocks and thus they are usually in different clock domains. Therefore, when the data transmission device 16 performs data transmission, it usually needs to perform cross-clock domain processing to convert the data in the first clock domain to the second clock domain, or to convert the data in the second clock domain to the first clock domain. In addition, since the communication protocols supported by the DTD module 14 and the coherent interconnection bus 12 of the chiplet are different, format conversion on the data is required during transmission.

In some embodiments, if the coherent interconnection bus 12 and the DTD module 14 are in the same clock domain, the first conversion module 162 may include a first format conversion unit 1621 but not a first synchronization unit 1622, and the second conversion module 165 may include a second format conversion unit 1651 but not a second synchronization unit 1652.

In some embodiments, a first receiver 161, a first format conversion unit 1621, a first synchronization unit 1622, and a first transmitter 163 are connected in sequence, and a second receiver 164, a second synchronization unit 1652, a second format conversion unit 1651, and a second transmitter 166 are connected in sequence. In other embodiments, a first receiver 161, a first synchronization unit 1622, a first format conversion unit 1621, and a first transmitter 163 are connected in sequence, and a second receiver 164, a second format conversion unit 1651, a second synchronization unit 1652, and a second transmitter 166 are connected in sequence.

In some embodiments, the first format conversion unit 1621 is configured to perform at least one of protocol conversion or bit width conversion, and the second format conversion unit 1651 is configured to perform at least one of protocol conversion or bit width conversion. Furthermore, the protocol conversion performed by the first format conversion unit 1621 and the protocol conversion performed by the second format conversion unit 1651 are the inverse processes of each other, and the bit width conversion performed by the first format conversion unit 1621 and the bit width conversion performed by the second format conversion unit 1651 are the inverse processes of each other.

Specifically, the protocol conversion performed by the first format conversion unit 1621 may include adding a preset frame header, and the bit width conversion performed may include one of data splicing and data splitting. Accordingly, the protocol conversion performed by the second format conversion unit 1651 may specifically include removing a preset frame header, and the bit width conversion performed may specifically include the other one of the data splicing and data splitting.

It can be understood that if the data bit width corresponding to the external interface of the coherent interconnection bus 12 is 1/n (n is an integer greater than 1) of the data bit width corresponding to the external interface of the DTD module 14, the bit width conversion performed by the first format conversion unit 1621 can specifically be splicing n data packets into one data packet (i.e., data splicing), and the bit width conversion performed by the second format conversion unit 1651 can specifically be splitting one data packet into n data packets (i.e., data splitting). Conversely, if the data bit width corresponding to the external interface of the coherent interconnection bus 12 is n times of the data bit width corresponding to the external interface of the DTD module 14, the bit width conversion performed by the first format conversion unit 1621 can specifically be splitting one data packet into n data packets (i.e., data splitting), and the bit width conversion performed by the second format conversion unit 1651 can be splicing n data packets into one data packet (i.e., data merging).

In the above embodiments, a first synchronization unit and a first format conversion unit are designed for the data transmission process from the coherent interconnection bus to the DTD module. These units can convert the frequency domain and data format corresponding to the first data to match those of the other side, so that the DTD module can correctly analysis the data. A second synchronization unit and a second format conversion unit are designed for the data transmission process from the DTD module to the coherent interconnection bus. These units can convert the frequency domain and data format corresponding to the second data to match those of the other side, so that the coherent interconnection bus can correctly analysis the data. This enables data transfer between the coherent interconnection bus and the DTD module.

Referring to FIG. 4, in some embodiments, the data transmission device 16 further includes an extraction module 167, which is connected to the second receiver 164 and the first transmitter 163 respectively and configured to identify whether a data signal sent by the DTD module 14 comprises a link establishment request or a link disconnection request.

The extraction module 167 is used to analysis the specific link establishment and disconnection information sent by the DTD module 14, so as to help establish and disconnect the communication link between the DTD module and the coherent interconnection bus. Regarding the identifying whether the data signal includes a link establishment request or a link disconnection request by the extraction module 167, please refer to the relevant descriptions of the link establishment and disconnection processes below.

In an embodiment, the data transmission device 16 may specifically include: a first receiver 161, a first format conversion unit 1621, a first synchronization unit 1622, a first transmitter 163, a second receiver 164, a second synchronization unit 1652, a second format conversion unit 1651, a second transmitter 166, and an extraction module 167.

The first receiver 161 is compatible with the external interface of the coherent interconnection bus 12 of the chiplet and configured to receive the first data from the coherent interconnection bus 12.

The first format conversion unit 1621 is connected to the first receiver 161 and configured to perform format conversion on the first data. For example, the first format conversion unit 1621 can be configured to splice the first data and then add a preset frame header, or add a preset frame header to the first data and then splice the data, or split the first data and then add a preset frame header.

The first synchronization unit 1622 is connected to the first format conversion unit 1621 and configured to perform cross-clock domain processing on the first data that has been subjected to the first format conversion.

The first transmitter 163 is connected to the first synchronization unit 1622 and compatible with the external interface of the DTD module 14, and configured to send the first data that has been subjected to the first format conversion and the cross-clock domain processing to the DTD module 14.

The second receiver 164 is compatible with the external interface of the DTD module 14 and configured to receive a second data from the DTD module 14.

The second synchronization unit 1652 is connected to the second receiver 164 and configured to perform across-clock domain processing on the second data.

The second format conversion unit 1651 is connected to the second synchronization unit 1652 and configured to perform format conversion on the second data that has been subjected to the cross-clock domain processing. For example, the second format conversion unit 1651 can be configured to remove a preset frame header from the second data that has been subjected to the cross-clock domain processing and then perform data splitting, or split the second data that has been subjected to the cross-clock domain processing and then remove the preset frame header, or remove the preset frame header from the second data that has been subjected to the cross-clock domain processing and then perform data splicing.

The second transmitter 166 is connected to the second format conversion unit 1651 and compatible with the external interface of the coherent interconnection bus 12, and configured to send the second data that has been subjected to the cross-clock domain processing and the format conversion to the coherent interconnection bus 12.

The extraction module 167 is connected to the second receiver 164 and the first transmitter 163 respectively, and configured to identify whether a data signal sent by the DTD module 14 comprises a link establishment request during the process of establishing a communication link between the coherent interconnection bus 12 and the DTD module 14, and also configured to identify whether a data signal sent by the DTD module 14 comprises a link disconnection request during the process of disconnecting the communication link between the coherent interconnection bus 12 and the DTD module 14.

In a specific embodiment, communication architecture between the DTD module and the coherent interconnection bus is described by taking the following as an example: the coherent interconnection bus is CMN600AE, whose external interface corresponds to version A of the CXS protocol (i.e., CXS.A) and supports data transmission of the CCIX 1.0 protocol (where CCIX stands for Cache Coherent Interconnect for Accelerators, a high-performance interconnect protocol); and the external interface of the DTD module corresponds to version B of the CXS protocol (i.e., CXS.B) and supports data transmission of the CXL 2.0/CCIX 2.0 protocol (where CXL stands for Compute Express Link, an open interconnect protocol).

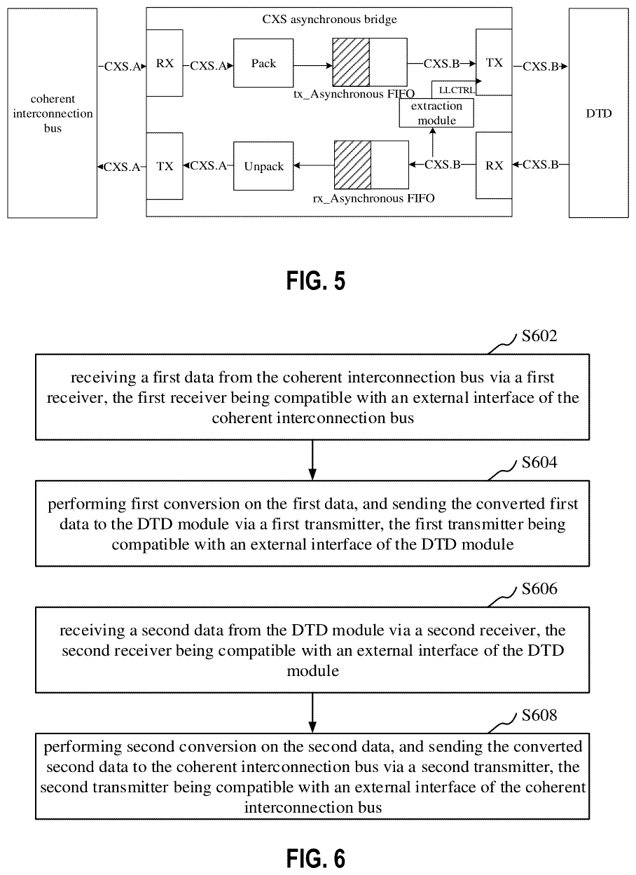

As shown in FIG. 5, the data transmission device of the present application (such as the CXS asynchronous bridge shown in FIG. 5, also known as CXSA2CXSB_Bridge) has two sets of CXS interfaces interconnected with CMN600AE and DTD module respectively, and two asynchronous First In First Outs (FIFOs) are used for cross-clock domain processing to synchronize data. The tx_Asynchronous FIFO is the first synchronization unit mentioned above, and the rx_Asynchronous FIFO is the second synchronization unit mentioned above. In FIG. 5, both tx_Asynchronous FIFO and rx_Asynchronous FIFO are represented by a combination of two different blocks, where the shaded blocks represent a frequency domain and the unshaded blocks represent another frequency domain. A Pack unit (i.e., the first format conversion unit mentioned above) and an Unpack unit (i.e., the second format conversion unit mentioned above) are used for protocol conversion and bit width conversion between CCIX 1.0 and CCIX 2.0. The extraction module (also known as LLCTL_EXTRACT) is used to analysis DTD-specific link establishment and link disconnection information. The data bit width of CXS.A is 256 bits, and the data bit width of CXS.B is 512 bits. When the CMN600AE sends data to the asynchronous bridge using the CXS.A interface, the asynchronous bridge adds a specific frame header to the data to achieve protocol conversion, and then splices two 256-bit CXS.A data into a 512-bit CXS.B data, thereby improving bandwidth utilization. Since CMN600AE and DTD module are designed asynchronously, tx_Asynchronous FIFO is used for synchronization, and then the converted data is sent to DTD module through the CXS.B interface. When DTD module sends data to CMN600AE, the asynchronous bridge receives the data sent by DTD module and processes it through rx_Asynchronous FIFO, and then the Unpack unit restores the data and sends it to the CMN600AE. In this way, data transmission between the DTD and CMN600AE is achieved.

It should be noted that each module or unit in the aforementioned data transmission device can be implemented entirely or partially through software, hardware, or a combination thereof. In some cases, the above modules or units can be implemented through circuits or subcircuits. In some cases, the above modules may be embedded in or independent of a processor in the computer device in a hardware form, or may be stored in a memory in the computer device in a software form, so that the processor can invokes and execute the corresponding operation of the above modules.

The data transmission method applied to the aforementioned data transmission device 16 will now be described in detail:

In an exemplary embodiment, as shown in FIG. 6, a data transmission method is provided, and the method comprises the steps 602 to 608.

In step 602, a first data from the coherent interconnection bus is received via a first receiver; the first receiver is compatible with an interface of the coherent interconnection bus.

The first receiver 161 is one of the interfaces in a set of interfaces of the data transmission device, and configured to receive the first data from the coherent interconnection bus 12. It is understood that the first receiver 161 is compatible with the external interface of the coherent interconnection bus 12 (that is, corresponding to the same interface protocol and protocol version) so as to be able to successfully receive the first data from the coherent interconnection bus 12.

In step 604, first conversion is performed on the first data, and the converted first data is sent to the DTD module via a first transmitter; the first transmitter is compatible with the external interface of the DTD module.

Specifically, the first conversion module 162 can perform first conversion on the first data received by the first receiver 161, and then send the converted first data to the DTD module 14 through the first transmitter 163, so as to achieve the data transmission from the coherent interconnection bus 12 to the DTD module 14. It is understood that the first transmitter 163 is compatible with the external interface of the DTD module 14 (i.e. corresponding to the same interface protocol and protocol version) so that the converted first data can be successfully sent to the DTD module 14.

In some embodiments, the coherent interconnection bus 12 and the DTD module 14 are driven by different clocks and thus operate at different clock frequencies, or even if the frequencies are the same, the phases may be different. Therefore, data transmission between different clock domains involves cross-clock domain processing, that is, the first conversion may specifically include cross-clock domain processing. For example, cross-clock domain processing may include asynchronous FIFO processing. FIFO is a first-in-first-out queue structure that can provide data buffering and synchronization feature between different clock domains. Asynchronous FIFO processing specifically involves controlling data to be written to the FIFO buffer from one clock domain and read from the same FIFO buffer from another clock domain, with the two clock domains being asynchronous to each other. Asynchronous FIFO processing is used to safely transfer data from one clock domain to another.

In some embodiments, the coherent interconnection bus 12 and the DTD module 14 support different data transmission protocols respectively. For example, the coherent interconnection bus CMN600AE supports the CCIX 1.0 protocol, while the DTD module supports the CXL 2.0/CCIX 2.0 protocol. Therefore, the first conversion may specifically include protocol conversion.

In some embodiments, the data bit width corresponding to the coherent interconnection bus 12 are different from that of the DTD module 14. For example, the data bit width of CXS.A is 256 bits, and the data bit width of CXS.B is 512 bits. Therefore, the first conversion may include bit width conversion.

In some embodiments, the first conversion may include at least one of cross-clock domain processing, protocol conversion, or bit width conversion.

In step 606, a second data from the DTD module is received via a second receiver; the second receiver is compatible with an external interface of the DTD module.

Similarly, in order to achieve the data transmission from the DTD module 14 to the coherent interconnection bus 12 of the chiplet, the data transmission device 16 of the present application is also designed with a second receiver 164 that is compatible with the interface of the DTD module 14 (i.e., corresponds to the same interface protocol and protocol version) to achieve the reception of the second data transmitted by the DTD module 14.

In step 608: second conversion is performed on the second data, and a transformed second data is sent to the coherent interconnection bus via the second transmitter; the second transmitter is compatible with an external interface of the coherent interconnection bus.

The second conversion module 165 of the data transmission device 16 can perform second conversion on the second data, and then send the converted second data to the coherent interconnection bus 12 through the second transmitter 166 of the data transmission device 16, so as to achieve the data transmission from the DTD module 14 to the coherent interconnection bus 12. It is understood that the second transmitter 166 is compatible with the external interface of the coherent interconnection bus 12 (i.e., corresponding to the same interface protocol and protocol version) so that the converted second data can be successfully sent to the coherent interconnection bus 12.

In some embodiments, the coherent interconnection bus 12 and the DTD module 14 are driven by different clocks and thus have different frequencies, so the second conversion may specifically include cross-clock domain processing to perform asynchronous FIFO processing on the data.

In some embodiments, the coherent interconnection bus 12 and the DTD module 14 support different data transmission protocols respectively. For example, the coherent interconnection bus CMN600AE supports the CCIX 1.0 protocol, while the DTD module supports the CXL 2.0/CCIX 2.0 protocol. Therefore, the second conversion may specifically include protocol conversion.

In some embodiments, the data bit width corresponding to the coherent interconnection bus 12 are different from that of the DTD module 14. For example, the data bit width of CXS.A is 256 bits, and the data bit width of CXS.B is 512 bits. Therefore, the second conversion may include bit width conversion.

In some embodiments, the second conversion may include at least one of cross-clock domain processing, protocol conversion, or bit width conversion. It can be understood that the first conversion and the second conversion are inverse processes of each other.

Furthermore, it should be noted that the present application does not limit the transmission timing of the first data and the second data, that is, the sequence between the above-mentioned steps 602 to 604 and the above-mentioned steps 606 to 608 is not limited. Steps 602 to 604 can be executed first, followed by steps 606 to 608; or steps 606 to 608 can be executed first, followed by steps 602 to 604; or steps 606 to 608 can be executed simultaneously with steps 602 to 604.

According to the aforementioned data transmission method, an asynchronous interface connection between the coherent interconnection bus of the chiplet and the DTD module is achieved through a set of interfaces adapted for connection with the coherent interconnection bus of the chiplet and a set of interfaces adapted for connection with the DTD module, so that data can be normally sent and received. Furthermore, data can be correctly transmitted by means of data conversion in a transmission process, thereby ensuring the normal operation of a chip system.

In some embodiments, performing the first conversion on the first data includes: performing cross-clock domain processing on the first data and then performing format conversion; and performing second conversion on the second data includes: performing format conversion on the second data and then performing cross-clock domain processing; or performing first conversion on the first data includes: performing format conversion on the first data and then performing cross-clock domain processing; performing second conversion on the second data includes: performing cross-clock domain processing on the second data and then performing format conversion.

Specifically, the format conversion step can be performed on the side with higher frequency to improve data processing efficiency. For example, if the frequency corresponding to the coherent interconnection bus 12 of the chiplet is lower than the frequency corresponding to the DTD module 14, then performing the first conversion on the first data includes: performing the cross-clock domain processing on the first data and then performing the format conversion to obtain the converted first data; performing the second conversion on the second data includes: performing the format conversion on the second data and then performing the cross-clock domain processing to obtain the converted second data. If the frequency corresponding to the coherent interconnection bus of the chiplet is higher than the frequency corresponding to the DTD module, then performing the first conversion on the first data includes: performing format conversion on the first data and then performing the cross-clock domain processing to obtain the converted first data; performing the second conversion on the second data includes: performing the cross-clock domain processing on the second data and then performing the format conversion to obtain the converted second data.

In some embodiments, if the coherent interconnection bus 12 of the chiplet and the DTD module 14 are in the same clock domain, that is, they correspond to the same frequency, then the first conversion and/or the second conversion may not include the cross-clock domain processing.

In some embodiments, the format conversion includes at least one of protocol conversion or bit width conversion; the protocol conversion includes at least one of adding a preset frame header or removing a preset frame header; and the bit width conversion includes at least one of data splicing or data splitting.

For example, when performing protocol conversion on the first data, a preset frame header may be added; when performing protocol conversion on the second data, a preset frame header may be removed. That is, the protocol conversion on the first data and the protocol conversion on the second data are the inverse processes of each other. It should be noted that the addition of a preset frame header to the data is intended to ensure that the converted data conforms to the protocol of the data recipient. For example, when the CMN600AE sends data to the data transmission device using the CXS.A interface, the first format conversion unit 1621 of the data transmission device 16 adds a specific frame header (i.e., the frame header corresponding to the data transmission protocol supported by the DTD module) to the data to achieve protocol conversion.

For example, when performing bit width conversion on the first data, data splicing can be performed, and when performing bit width conversion on the second data, data splitting can be performed; conversely, when performing bit width conversion on the first data, data splitting can be performed, and when performing bit width conversion on the second data, data splicing can be performed. That is, the bit width conversion corresponding to the first data and the bit width conversion corresponding to the second data are the inverse processes of each other. It should be noted that the data splicing is intended to improve bandwidth utilization during data transmission. For example, the data bit width corresponding to the CXS.A is 256 bits, and the data bit width corresponding to the CXS.B is 512 bits. The data transmission device can splice two 256-bit CXS.A data into one 512-bit CXS.B data for transmission, thereby improving bandwidth utilization.

Therefore, when transmitting data, at least one format conversion (e.g., protocol conversion or bit width conversion) is performed on the transmitted data so that the converted data can be parsed by the data recipient, thus ensuring the proper operation of the system.

In some embodiments, there are at least the following cases in which format conversion is performed on the first data and format conversion is performed on the second data.

In the first case, the data transmission protocols supported by the coherent interconnection bus 12 and the data transmission protocols supported by the DTD module 14 are different, and the data bit width corresponding to the external interface of the coherent interconnection bus 12 is less than the data bit width corresponding to the external interface of the DTD module 14. In this case, the format conversion on the first data and the format conversion on the second data can be specifically as follows: a preset frame header can be added to the first data and then packet merging (i.e., data splicing) can be performed, and accordingly packet unpacking (i.e., data splitting) can be performed on the second data and then the preset frame headers can be removed from the multiple pieces of data obtained from the unpacking. Alternatively, packet merging can be performed on the first data and then a preset frame header can be added, and accordingly the preset frame header in the second data can be removed and then the resulting second data can be unpacked.

In the second case, the data transmission protocols supported by the coherent interconnection bus 12 and the data transmission protocols supported by the DTD module 14 are different, and the data bit width corresponding to the external interface of the coherent interconnection bus 12 is greater than the data bit width corresponding to the external interface of the DTD module 14. In this case, the format conversion on the first data and the format conversion on the second data can be specifically as follows: packet unpacking can be performed on the first data and then the preset frame headers can be added to the multiple pieces of data obtained from the unpacking, and accordingly the preset frame headers in multiple second data can be removed and then packing processing is performed on the second data obtained.

In the above embodiments, during the transmission of the first data and/or the second data, format conversion and cross-clock domain processing are performed to ensure that the format and clock domain of the converted data can match the data recipient, thus avoiding situations where the data recipient cannot analyze the data or experiences data reception failures. This ensures that both the coherent interconnection bus and the DTD module can function normally.

In some embodiments, before data transmission is performed between the coherent interconnection bus 12 of the chiplet and the DTD module 14, communication links (including a first link and a second link) between the DTD module 14 and the coherent interconnection bus 12 needs to be established to ensure that subsequent data transmission can be achieved. That is, the data transmission method may also include a link establishment process, which may specifically include the following steps: establishing a first link between the DTD module 14 and the coherent interconnection bus 12, the first link being used for the transmission of the second data; and establishing a second link between the coherent interconnection bus 12 and the DTD module 14, the second link being used for the transmission of the first data.

It can be understood that once the first link and the second link are successfully established, the first and second data can be transmitted smoothly, enabling the coherent interconnection bus 12 of the chiplet to be successfully interconnected with the DTD module 14.

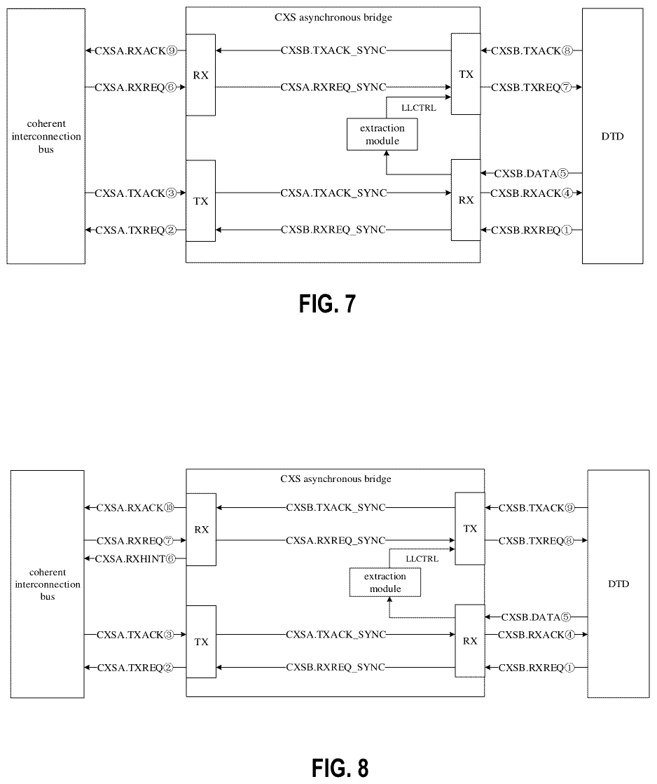

The establishment process of the first and second links will be explained in detail below with reference to FIG. 7.

In some embodiments, establishing a first link between the DTD module 14 and the coherent interconnection bus 12 includes: synchronizing, in response to a first request signal from the DTD module 14 being in a high-level state, the first request signal that is in the high-level state; setting a second request signal to the high-level state once the synchronization is done, the second request signal in the high-level state being used to instruct the coherent interconnection bus 12 to set a first acknowledgment signal to the high-level state; synchronizing, in response to the first acknowledgment signal from the coherent interconnection bus 12 being in the high-level state, the first acknowledgment signal that is in the high-level state; and setting a second acknowledgment signal to the high-level state once the synchronization is done, so as to accomplish an establishment of the first link.

In some embodiments, when different DTD modules start operation, they will connect to each other. Once any DTD module successfully connects to other DTD modules, it can pull up the first request signal to the high-level state, that is, set the first request signal to the high-level state (such as logic “1”), so as to wake up the second receiver 164. In this way, when the data transmission device 16 detects that the first request signal is in a high-level state, it will synchronize the first request signal that is in a high-level state. This synchronization may involve, for example, synchronizing the first request signal that is in the high-level state to the clock domain of the coherent interconnection bus 12 and optionally or additionally performing a handshake. Once synchronization is done, the first request synchronization signal is set to the high-level state. When the data transmission device 16 detects that the first request synchronization signal is in the high-level state, it pulls up the second request signal to the high-level state (that is, sets the second request signal to the high-level state). In response to the second request signal being in the high-level state, the coherent interconnection bus 12 of the chiplet pulls up the first acknowledgment signal to the high-level state. The data transmission device 16 synchronizes the first acknowledgment signal that is in the high-level state, and sets a first acknowledgment synchronization signal to the high-level state once the synchronization is done. This synchronization may involve, for example, synchronizing the first acknowledgment signal that is in the high-level state to the clock domain of the DTD module 14 and optionally or additionally performing a handshake. After the data transmission device 16 detects the first acknowledgment synchronization signal in the high-level state, it pulls up the second acknowledgment signal to the high-level state. At this point, the first link has been successfully established.

Specifically, the synchronization of signal may specifically include the cross-clock domain processing, which converts the frequency of the signal to match that of the data recipient. The synchronization of signal can be performed by the same module as used for the aforementioned cross-clock domain processing, or by a different module. The embodiments of the present application are not limited in this regard.

In the above embodiments, the first link is established by pulling up the relevant signal to the high-level state, which implements both the request process (from the DTD module to the coherent interconnection bus) and the acknowledgment process (from the coherent interconnection bus to the DTD module), thereby enabling the transmission of the first data through the first link.

In some embodiments, establishing the second link between the coherent interconnection bus 12 and the DTD module 14 includes: synchronizing, in response to a third request signal from the coherent interconnection bus 12 being in a high-level state, the third request signal that is in the high-level state; setting a fourth request signal to the high-level state once the synchronization is done and a link establishment request is received from the DTD module 14, the fourth request signal in the high-level state being used to instruct the DTD module 14 to set a third acknowledgment signal to the high-level state; synchronizing, in response to the third acknowledgment signal from the DTD module 14 being in the high-level state, the third acknowledgment signal that is in a high-level state; and setting a fourth acknowledgment signal to the high-level state once the synchronization is done, so as to accomplish an establishment of the second link.

After the first link is successfully established, the TDT module 14 can transmit the link establishment request via data signals. Upon receiving the data signal from the DTD module 14, the data transmission device 16 analyze the data signal. If the data in the data signal complies with the preset link establishment rules, the data transmission device 16 determines that a link establishment request has been received. The data in the data signal complies with the preset link establishment rules, which may be indicated, for example, by the value of a preset bit in the data signal being 1.

If the data transmission device 16 receives a third request signal that is in a high-level state transmitted from the coherent interconnection bus 12, it synchronizes the third request signal that is in the high-level state. This synchronization may involve, for example, synchronizing the third request signal that is in the high-level state to the clock domain of the DTD module 14 and optionally or additionally performing a handshake. If synchronization is done, the third synchronization request signal will be set to the high-level state. If the data transmission device 16 detects that the third request synchronization signal is in the high-level state and receives the link establishment request transmitted by the DTD module 14, it pulls up the fourth request signal to the high-level state. Then the DTD module 14 can pull up the third acknowledgment signal to the high-level state, so that the data transmission device 16 can synchronize the third acknowledgment signal. This synchronization may involve, for example, synchronizing the third acknowledgment signal that is in the high-level state to the clock domain of the coherent interconnection bus 12 and optionally or additionally performing a handshake. After synchronization is done, the third acknowledgment synchronization signal is set to the high level. If the data transmission device 16 detects that the third acknowledgment synchronization signal is in the high-level state, it will set the fourth acknowledgment signal to the high-level state. At this point, the second link also be successfully established.

In the above embodiments, the second link is established by pulling up the relevant signal to the high-level state, which implements both the request process (from the coherent interconnection bus to the DTD module) and the acknowledgment process(from the DTD module to the coherent interconnection bus), thereby enabling the transmission of the second data through this second link.

Specifically, please refer to FIG. 7, which illustrates the link establishment process of the first and second links in an embodiment, and the link establishment process includes the following steps.
1) The DTD module pulls up the first request signal CXSB.RXREQ to the high-level state to wake up the CXS.B interface (i.e. the second receiver). Meanwhile, the first request signal CXSB.RXREQ is synchronized, while the second acknowledgment signal CXSB.RXACK is not pulled up.
2) Upon receiving the synchronized first request synchronization signal CXSB.RXREQ_SYNC, the asynchronous bridge pulls up the second request signal CXSA.TXREQ to the high-level state.
3) When the CMN pulls up the first acknowledgment signal CXSA.TXACK in response, the first acknowledgment signal CXSA.TXACK is synchronized.
4) Upon receiving the synchronized first acknowledgment synchronization signal CXSA.TXACK_SYNC, the asynchronous bridge pulls up the second acknowledgment signal CXSB.RXACK to the high-level state. At this point, the link shown in the lower section of FIG. 7 has been successfully established.
5) The DTD module can transmit a link establishment request via data signal CXSB.DATA, and then the extraction module LLCTRL will cause the asynchronous bridge to initiate the link establishment request.
6) CMN pulls up the third request signal CXSA.RXREQ to the high-level state, and the third request signal CXSA.RXREQ is synchronized.
7) When the third request synchronization signal CXSA.RXREQ_SYNC is detected and a link establishment request is received, the asynchronous bridge pulls up the fourth request signal CXSB.TXREQ to the high-level state.
8) DTD module pulls up the third acknowledgment signal CXSB.TXACK to the high-level state in response, and simultaneously the third acknowledgment signal CXSB.TXACK is synchronized.
9) Upon receiving the synchronized third acknowledgment synchronization signal CXSB.TXACK_SYNC, the asynchronous bridge pulls up the fourth acknowledgment signal CXSA.RXACK to the high-level state. At this point, the link shown in the upper section of FIG. 7 has been successfully established.

It should be noted that in an asynchronous bridge, the transmission and reception of relevant signals are accomplished via their respective transmitters and receivers.

After the first link and the second link are successfully established, the coherent interconnection bus 12 of the chiplet and the DTD module 14 can transmit data via the first link and the second link, thereby enabling the data transmission between different chiplets. If the link disconnection condition is met, the first and second links are disconnected to conserve resources. Specifically, the disconnection condition can be met if DTD module 14 fails, or if no data is transmitted between the coherent interconnection bus 12 and DTD module 14 within a preset time window.

In some embodiments, the data transmission method may further include a link disconnection process, namely, the following steps: disconnecting a first link between the DTD module 14 and the coherent interconnection bus 12, the first link being the link used during the transmission of the second data; and disconnecting a second link between the coherent interconnection bus 12 and DTD module 14; and the second link is the link used during the transmission of the first data.

It can be understood that after the first link and the second link are disconnected, the coherent interconnection bus 12 of the chiplet and DTD module 14 cannot communicate, which can reduce resource consumption in some cases.

The disconnection process of the first and second links will be explained in detail below with reference to FIG. 8.

In some embodiments, disconnecting the first link between the DTD module and the coherent interconnection bus includes: synchronizing, in response to a first request signal from the DTD module 14 being in a low-level state, the first request signal that is in the low-level state; setting a second request signal to the low-level state once the synchronization is done; and the second request signal in the low-level state being used to instruct the coherent interconnection bus 12 to set a first acknowledgment signal to the low-level state; synchronizing, in response to the first acknowledgment signal from the coherent interconnection bus 12 being in the low-level state, the first acknowledgment signal that is in the low-level state; and setting a second acknowledgment signal to the low-level state once the synchronization is done, so as to disconnect the first link.

In some embodiments, when a link disconnection is required, the DTD module 14 can pull down the first request signal to the low-level state, that is, set the first request signal to the low-level state (such as logic “0”). Thus, when the data transmission device 16 detects that the first request signal is in the low-level state, it will synchronize the first request signal that is in the low-level state. This synchronization may involve, for example, synchronizing the first request signal that is in the low-level state to the clock domain of the coherent interconnection bus 12 and optionally or additionally performing a handshake. Once synchronization is done, the data transmission device 16 pulls down the second request signal to the low-level state (that is, set the second request signal to the low-level state). In response to the second request signal being in the low-level state, the coherent interconnection bus 12 of the chiplet pulls down the first acknowledgment signal to the low-level state. The data transmission device 16 synchronizes the first acknowledgment signal that is in the low-level state, and pulls down the second acknowledgment signal to the low-level state once the synchronization is done. This synchronization may involve, for example, synchronizing the first acknowledgment signal that is in the high-level state to the clock domain of the DTD module 14 and optionally or additionally performing a handshake. At this point, the first link has been successfully disconnected.

Specifically, the synchronization of signal may specifically include the cross-clock domain processing, which converts the frequency of the signal to match that of the data receiver. The synchronization of signal can be performed by the same module as used for the aforementioned cross-clock domain processing, or by a different module. The embodiments of the present application are not limited in this regard.

In the above embodiments, the first link is disconnected by pulling down the relevant signal to the low-level state, which terminates the request process (from the DTD module to the coherent interconnection bus) and the acknowledgment process (from the coherent interconnection bus to the DTD module).

In some embodiments, disconnecting the second link between the coherent interconnection bus 12 and the DTD module 14 includes: setting a hint signal to a high-level state, the hint signal in the high-level state being used to instruct the coherent interconnection bus 12 to set a third request signal to a low-level state; synchronizing, in response to the third request signal from the coherent interconnection bus 12 being in the low-level state, the third request signal that is in a low-level state; setting a fourth request signal to the low-level state if the synchronization is done and a link disconnection request is received from the DTD module 14, the fourth request signal in the low-level state being used to instruct the DTD module 14 to set a third acknowledgment signal to the low-level state; synchronizing, in response to the third acknowledgment signal from the DTD module 14 being in the low-level state, the third acknowledgment signal that is in a low-level state; and setting a fourth acknowledgment signal to the low-level state once the synchronization is done, so as to disconnect the second link.

After the first link is successfully disconnected, the DTD module 14 can transmit the link disconnection request via data signals. Upon receiving the data signal from the DTD module 14, the data transmission device 16 analyze the data signal. If the data in the data signal complies with the preset link disconnection rules, the data transmission device 16 determines that a link disconnection request has been received. The data in the data signal complies with the preset link disconnection rules, which may be indicated, for example, by the value of a preset bit in the data signal being 0.

The data transmission device 16 pulls up the hint signal to the high-level state and sends the hint signal in the high-level state to the coherent interconnection bus 12 of the chiplet. If the coherent interconnection bus 12 detects the hint signal that is in a high-level state, it pulls down the third request signal to the low-level state. If the data transmission device 16 receives a third request signal that is in a low-level state transmitted from the coherent interconnection bus 12, it synchronizes the third request signal that is in a low-level state. This synchronization may involve, for example, synchronizing the third request signal that is in the low-level state to the clock domain of the DTD module 14 and optionally or additionally performing a handshake. If synchronization is done and a link disconnection request is received from the DTD module 14, the data transmission device 16 pulls down the fourth request signal to the low-level state. Then the DTD module 14 can pull down the third acknowledgment signal to the low-level state, so that the data transmission device 16 can synchronize the third acknowledgment signal. This synchronization may involve, for example, synchronizing the third acknowledgment signal that is in the low-level state to the clock domain of the coherent interconnection bus 12 and optionally or additionally performing a handshake. Once synchronization is done, the fourth acknowledgment signal is set to the low-level state. At this point, the second link is successfully disconnected.

In the above embodiments, the second link is disconnected by pulling down the relevant signal to the low-level state, which terminates the request process (from the coherent interconnection bus to the DTD module) and the acknowledgment process (from the DTD module to the coherent interconnection bus).

Specifically, please refer to FIG. 8, which illustrates the link disconnection process of the first and second links in an embodiment, and the link disconnection process includes the following steps.
1) When the DTD module pulls down the first request signal CXSB.RXREQ to the low-level state, the asynchronous bridge will synchronize the first request signal CXSB.RXREQ upon receiving it, but will not pull down the second acknowledgment signal CXSB.RXACK to the low-level state.
2) Upon receiving the synchronized signal CXSB.RXREQ_SYNC, the asynchronous bridge pulls down the second request signal CXSA.TXREQ to the low-level state.
3) When the CMN pulls down the first acknowledgment signal CXSA.TXACK to the low-level state in response, the asynchronous bridge will simultaneously synchronize the first acknowledgment signal CXSA.TXACK upon receiving it.
4) Upon receiving the synchronized signal CXSA.TXACK_SYNC, the asynchronous bridge pulls down the second acknowledgment signal CXSB.RXACK to the low-level state. At this point, the link shown in the lower section of FIG. 8 has been successfully disconnected.
5) The DTD module can transmit a link disconnection request to the LLCTRL via the data signal CXSB.DATA to cause the asynchronous bridge to initiate a link disconnection request.
6) The asynchronous bridge pulls up the hint signal CXSA.RXHINT to the high-level state.
7) After the hint signal CXSA.RXHINT has been pulled up to the high-level state, CMN will pull down the third request signal CXSA.RXREQ to the low-level state. The asynchronous bridge will simultaneously synchronize the third request signal CXSA.RXREQ upon receiving it.
8) After the asynchronous bridge receives the synchronized CXSA.RXREQ_SYNC, it pulls down the fourth request signal CXSB.TXREQ to the low-level state.
9) DTD module pulls down the third acknowledgment signal CXSB.TXACK to the low-level state, and the asynchronous bridge synchronize the third acknowledgment signal CXSB.TXACK. 10) Upon receiving the synchronized signal CXSB.TXACKSYNC, the asynchronous bridge pulls down the fourth acknowledgment signal CXSA.RXACK to the low-level state. At this point, the link shown in the upper section of FIG. 8 has been successfully disconnected.

It should be noted that in an asynchronous bridge, the transmission and reception of relevant signals are accomplished via their respective transmitters and receivers.

In some embodiments, the data transmission method includes the following steps:
establishing a first link between the DTD module and the coherent interconnection bus, which includes: synchronizing, in response to a first request signal from the DTD module being in a high-level state, the first request signal that is in the high-level state; setting a second request signal to the high-level state once the synchronization is done, the second request signal in the high-level state being used to instruct the coherent interconnection bus to set a first acknowledgment signal to the high-level state; synchronizing, in response to the first acknowledgment signal from the coherent interconnection bus being in the high-level state, the first acknowledgment signal that is in the high-level state; and setting a second acknowledgment signal to the high-level state once the synchronization is done, so as to accomplish an establishment of the first link; the first link being used for the transmission of the second data;
establishing a second link between the coherent interconnection bus and the DTD module, which includes: synchronizing, in response to a third request signal from the coherent interconnection bus being in the high-level state, the third request signal that is in the high-level state; setting a fourth request signal to the high-level state once the synchronization is done and a link establishment request is received from the DTD module, the fourth request signal in the high-level state being used to instruct the DTD module to set a third acknowledgment signal to the high-level state; synchronizing, in response to the third acknowledgment signal from the DTD module being in the high-level state, the third acknowledgment signal that is in the high-level state; and setting a fourth acknowledgment signal to the high-level state once the synchronization is done, so as to accomplish an establishment of the second link, the second link being used for the transmission of the first data transmission;
receiving a first data from the coherent interconnection bus via a first receiver, the first receiver is compatible with an external interface of the coherent interconnection bus; performing first conversion on the first data, and sending the converted first data to the DTD module via a first transmitter, the first transmitter being compatible with an external interface of the DTD module; the first conversion including the cross-clock domain processing, and at least one of the protocol conversion or the bit width conversion;
receiving a second data from the DTD module via a second receiver; the second receiver being compatible with an external interface of the DTD module; and performing second conversion of the second data, and sending the converted second data to the coherent interconnection bus via a second transmitter, the second transmitter being compatible with an external interface of the coherent interconnection bus; the second conversion including at least one of the protocol conversion or the bit width conversion, as well as the cross-clock domain processing;
disconnecting a first link between the DTD module and the coherent interconnection bus, which includes: synchronizing, in response to a first request signal from the DTD module being in a low-level state, the first request signal that is in the low-level state; setting a second request signal to the low-level state once the synchronization is done, the second request signal in the low-level state being used to instruct the coherent interconnection bus to set a first acknowledgment signal to the low-level state; synchronizing, in response to the first acknowledgment signal from the coherent interconnection bus being in the low-level state, the first acknowledgment signal that is in the low-level state; and setting a second acknowledgment signal to the low-level state once the synchronization is done, so as to disconnect the first link; and
disconnecting the second link between the coherent interconnection bus and the DTD module, which includes: setting a hint signal to a high-level state, the hint signal in the high-level state being used to instruct the coherent interconnection bus to set a third request signal to a low-level state; synchronizing, in response to the third request signal from the coherent interconnection bus being in the low-level state, the third request signal that is in the low-level state; setting a fourth request signal to the low-level state once the synchronization is done and a link disconnection request is received from the DTD module, the fourth request signal in the low-level state being used to instruct the DTD module to set a third acknowledgment signal to the low-level state; synchronizing, in response to the third acknowledgment signal from the DTD module being in the low-level state, the third acknowledgment signal that is in the low-level state; and setting a fourth acknowledgment signal to the low-level state once the synchronization is done, so as to disconnect the second link.

In the above embodiments, asynchronous CXS interface connections are achieved by using a novel design. Furthermore, in order to enable the DTD module 14 to recognize the protocol corresponding to the coherent interconnection bus (such as the CCIX1.0 protocol of CMN600AE), a CCIX2.0 frame header can be directly added to the CCIX1.0 data during format conversion, avoiding the trouble caused by parsing CCIX1.0 data. In addition, the present application also implements CXS interface connection with different data bit widths which improves bandwidth utilization. In addition, the present application also designs a link establishment and disconnection process to adapt to the coherent interconnection bus and the DTD module, so as to ensure the normal operation of the system.

It should be understood that although the steps in the flowcharts of the above embodiments are shown sequentially according to the instruction of the arrows, these steps are not necessarily executed in the sequence indicated by the arrows. Unless expressly stated in this specification, these steps are not performed in a strict sequence, and these steps may be performed in another sequence. Moreover, at least some steps in the flowcharts involved in the above embodiments may include multiple steps or multiple phases. These steps or phases are not necessarily completed at the same time, but can be executed at different times. The execution sequence of these steps or phases is not necessarily sequential, but can be executed in turn or alternately with other steps or with at least some of the steps or phases in other steps.

In an exemplary embodiment, as shown in FIG. 1, a chiplet 10 is provided, which includes a coherent interconnection bus, a data transmission device, a DTD module, a processor, and a memory. The processor is configured to provide computing and control capabilities. Memory includes non-transitory storage medium and internal memory. The non-transitory storage medium stores computer programs. This internal memory provides an environment for the execution of computer programs on non-transitory storage medium. When the computer program is executed by the processor, it implements a data transmission method.

Those skilled in the art will understand that the structure shown in FIG. 1 is merely a block diagram of a portion of the structure related to the present application and does not constitute a limitation on the computer device to which the present application is applied. Specific computer devices may include more or fewer components than those shown in the figure, or may combine certain components, or may have different component arrangements.

In an embodiment, a chiplet is also provided, including a coherent interconnection bus, a data transmission device, a DTD module, a memory, and a processor. The memory stores a computer program that, when executed by the processor, implement the steps in the above method embodiments.

In an embodiment, a computer-readable storage medium is provided, having a computer program stored thereon that, when executed by a processor, implements the steps in the above method embodiments.

In an embodiment, a computer program product is provided, including a computer program that, when executed by a processor, implements the steps in the above method embodiments.

Those skilled in the art will understand that all or part of the processes in the above embodiments can be implemented by a computer program instructing related hardware. The computer program can be stored in a non-transitory computer-readable storage medium. When the computer program is executed, it can include the processes of the embodiments of the above methods. Any references to memory, database or other media used in the embodiments provided in the present application may include at least one of non-transitory memory and transitory memory. Non-transitory memory can include read-only memory (ROM), magnetic tape, floppy disk, flash memory, optical memory, high-density embedded non-transitory memory, resistive random access memory (ReRAM), magnetic random access memory (MRAM), ferroelectric random access memory (FRAM), phase change memory (PCM), graphene memory, etc. The transitory memory may include random access memory (RAM) or external cache memory, etc. By way of illustration and not limitation, RAM can take many forms, such as Static Random Access Memory (SRAM) or Dynamic Random Access Memory (DRAM). The databases involved in the various embodiments provided in the present application may include at least one of relational databases and non-relational databases. Non-relational databases can include, but are not limited to, blockchain-based distributed databases. The processors involved in the various embodiments provided in the present application may be general-purpose processors, central processing units, graphics processors, digital signal processors, programmable logic devices, quantum computing-based data processing logic devices, artificial intelligence (AI) processors, etc., and are not limited thereto.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A data transmission method applied to a data transmission device of a chiplet, wherein the chiplet is further equipped with a coherent interconnection bus and a Die to Die (DTD) circuit, and the method comprises:
receiving a first data from the coherent interconnection bus via a first receiver, the first receiver being compatible with an external interface of the coherent interconnection bus;
performing first conversion on the first data, and sending the converted first data to the DTD circuit via a first transmitter, the first transmitter being compatible with an external interface of the DTD circuit;
receiving a second data from the DTD circuit via a second receiver, the second receiver being compatible with an external interface of the DTD circuit; and
performing second conversion on the second data, and sending the converted second data to the coherent interconnection bus via a second transmitter, the second transmitter being compatible with an external interface of the coherent interconnection bus.

2. The method according to claim 1, wherein performing the first conversion on the first data comprises: performing cross-clock domain processing on the first data and then performing format conversion; and performing the second conversion on the second data comprises: performing format conversion on the second data and then performing cross-clock domain processing; or
performing the first conversion on the first data comprises: performing format conversion on the first data and then performing cross-clock domain processing; performing the second conversion on the second data comprises: performing cross-clock domain processing on the second data and then performing format conversion.

3. The method according to claim 2, wherein the format conversion comprises at least one of protocol conversion or bit width conversion; the protocol conversion comprises at least one of adding a preset frame header or removing a preset frame header; and the bit width conversion comprises at least one of data splicing or data splitting.

4. The method according to claim 1, further comprising:
establishing a first link between the DTD circuit and the coherent interconnection bus, the first link being used for the transmission of the second data; and
establishing a second link between the coherent interconnection bus and the DTD circuit, the second link being used for the transmission of the first data.

5. The method according to claim 4, wherein establishing the first link between the DTD circuit and the coherent interconnection bus comprises:
synchronizing, in response to a first request signal from the DTD circuit being in a high-level state, the first request signal that is in the high-level state;
setting a second request signal to the high-level state once the synchronization is done, the second request signal in the high-level state being used to instruct the coherent interconnection bus to set a first acknowledgment signal to the high-level state;
synchronizing, in response to the first acknowledgment signal from the coherent interconnection bus being in the high-level state, the first acknowledgment signal that is in the high-level state; and
setting a second acknowledgment signal to the high-level state once the synchronization is done, so as to accomplish an establishment of the first link.

6. The method according to claim 4, wherein establishing the second link between the coherent interconnection bus and the DTD circuit comprises:
synchronizing, in response to a third request signal from the coherent interconnection bus being in a high-level state, the third request signal that is in the high-level state;
setting a fourth request signal to the high-level state once the synchronization is done and a link establishment request is received from the DTD circuit, the fourth request signal in the high-level state being used to instruct the DTD circuit to set a third acknowledgment signal to the high-level state;
synchronizing, in response to the third acknowledgment signal from the DTD circuit being in the high-level state, the third acknowledgment signal that is in the high-level state; and
setting a fourth acknowledgment signal to the high-level state once the synchronization is done, so as to accomplish an establishment of the second link.

7. The method according to claim 1, further comprising:
disconnecting a first link between the DTD circuit and the coherent interconnection bus, the first link being the link used during the transmission of the second data; and
disconnecting a second link between the coherent interconnection bus and the DTD circuit, second link being the link used during the transmission of the first data transmission.

8. The method according to claim 7, wherein disconnecting the first link between the DTD circuit and the coherent interconnection bus comprises:
synchronizing, in response to a first request signal from the DTD circuit being in a low-level state, the first request signal that is in the low-level state;
setting a second request signal to the low-level state once the synchronization is done, the second request signal in the low-level state being used to instruct the coherent interconnection bus to set a first acknowledgment signal to the low-level state;
synchronizing, in response to the first acknowledgment signal from the coherent interconnection bus being in the low-level state, the first acknowledgment signal that is in the low-level state; and
setting a second acknowledgment signal to the low-level state once the synchronization is done, so as to disconnect the first link.

9. The method according to claim 7, wherein disconnecting the second link between the coherent interconnection bus and the DTD circuit comprises:
setting a hint signal to a high-level state, the hint signal in the high-level state being used to instruct the coherent interconnection bus to set a third request signal to a low-level state;
synchronizing, in response to the third request signal from the coherent interconnection bus being in the low-level state, the third request signal that is in the low-level state;
setting a fourth request signal to the low-level state once the synchronization is done and a link disconnection request is received from the DTD circuit, the fourth request signal in the low-level state being used to instruct the DTD circuit to set a third acknowledgment signal to the low-level state;
synchronizing, in response to the third acknowledgment signal from the DTD circuit being in the low-level state, the third acknowledgment signal that is in the low-level state; and
setting a fourth acknowledgment signal to the low-level state once the synchronization is done, so as to disconnect the second link.

10. A data transmission device, comprising:
a first receiver, compatible with an external interface of a coherent interconnection bus of a chiplet and configured to receive a first data from the coherent interconnection bus;
a first conversion circuit, connected to the first receiver and configured to perform first conversion on the first data received by the first receiver;
a first transmitter, connected to the first conversion circuit and compatible with an external interface of a Die to Die (DTD) circuit, and configured to send the converted first data to the DTD circuit;
a second receiver, compatible with an external interface of the DTD circuit and configured to receive a second data from the DTD circuit;
a second conversion circuit, connected to the second receiver and configured to perform second conversion on the second data received by the second receiver; and
a second transmitter, connected to the second conversion circuit and compatible with an external interface of the coherent interconnection bus and configured to send the converted second data to the coherent interconnection bus.

11. The device according to claim 10, wherein the first conversion circuit comprises a first format conversion subcircuit and a first synchronization subcircuit, the first format conversion subcircuit is configured to perform format conversion on the first data, and the first synchronization subcircuit is configured to perform cross-clock domain processing on the first data; and
the second conversion circuit comprises a second format conversion subcircuit and a second synchronization subcircuit, the second format conversion subcircuit is configured to perform format conversion on the second data, and the second synchronization subcircuit is configured to perform cross-clock domain processing on the second data.

12. The device according to claim 10, wherein the device further comprises an extraction circuit, which is connected to the second receiver and the first transmitter respectively and configured to identify whether a data signal sent by the DTD circuit comprises a link establishment request or a link disconnection request.

13. A chiplet, comprising a coherent interconnection bus, a data transmission device, a Die to Die (DTD) circuit, a memory, and a processor, wherein the memory stores a computer program, when executed by the processor causing the processor to perform a method, the method comprising:
receiving a first data from the coherent interconnection bus via a first receiver, the first receiver being compatible with an external interface of the coherent interconnection bus; performing first conversion on the first data, and sending the converted first data to the DTD circuit via a first transmitter, the first transmitter being compatible with an external interface of the DTD circuit;
receiving a second data from the DTD circuit via a second receiver, the second receiver being compatible with an external interface of the DTD circuit; and
performing second conversion on the second data, and sending the converted second data to the coherent interconnection bus via a second transmitter, the second transmitter being compatible with an external interface of the coherent interconnection bus.

14. The chiplet according to claim 13, wherein performing the first conversion on the first data comprises: performing cross-clock domain processing on the first data and then performing format conversion; and performing the second conversion on the second data comprises: performing format conversion on the second data and then performing cross-clock domain processing; or
performing the first conversion on the first data comprises: performing format conversion on the first data and then performing cross-clock domain processing; performing the second conversion on the second data comprises: performing cross-clock domain processing on the second data and then performing format conversion.

15. The chiplet according to claim 14, wherein the format conversion comprises at least one of protocol conversion or bit width conversion; the protocol conversion comprises at least one of adding a preset frame header or removing a preset frame header; and the bit width conversion comprises at least one of data splicing or data splitting.

16. The chiplet according to claim 13, wherein the method further comprises:
establishing a first link between the DTD circuit and the coherent interconnection bus, the first link being used for the transmission of the second data; and
establishing a second link between the coherent interconnection bus and the DTD circuit, the second link being used for the transmission of the first data.

17. The chiplet according to claim 16, wherein establishing the first link between the DTD circuit and the coherent interconnection bus comprises:
synchronizing, in response to a first request signal from the DTD circuit being in a high-level state; the first request signal that is in the high-level state;
setting a second request signal to the high-level state once the synchronization is done, the second request signal in the high-level state being used to instruct the coherent interconnection bus to set a first acknowledgment signal to the high-level state;
synchronizing, in response to the first acknowledgment signal from the coherent interconnection bus being in the high-level state, the first acknowledgment signal that is in the high-level state; and
setting a second acknowledgment signal to the high-level state once the synchronization is done, so as to accomplish an establishment of the first link.

18. The chiplet according to claim 16, wherein establishing the second link between the coherent interconnection bus and the DTD circuit comprises:
synchronizing, in response to a third request signal from the coherent interconnection bus being in a high-level state, the third request signal that is in the high-level state;
setting a fourth request signal to the high-level state once the synchronization is done and a link establishment request is received from the DTD circuit, the fourth request signal in the high-level state being used to instruct the DTD circuit to set a third acknowledgment signal to the high-level state;
synchronizing, in response to the third acknowledgment signal from the DTD circuit being in the high-level state, the third acknowledgment signal that is in the high-level state; and
setting a fourth acknowledgment signal to the high-level state once the synchronization is done, so as to accomplish an establishment of the second link.

19. The chiplet according to claim 13, wherein the method further comprises:
disconnecting a first link between the DTD circuit and the coherent interconnection bus, the first link being the link used during the transmission of the second data; and
disconnecting a second link between the coherent interconnection bus and the DTD circuit, second link being the link used during the transmission of the first data transmission.

20. The chiplet according to claim 19,
wherein disconnecting the first link between the DTD circuit and the coherent interconnection bus comprises:
synchronizing, in response to a first request signal from the DTD circuit being in a low-level state, the first request signal that is in the low-level state;
setting a second request signal to the low-level state once the synchronization is done, the second request signal in the low-level state being used to instruct the coherent interconnection bus to set a first acknowledgment signal to the low-level state;
synchronizing, in response to the first acknowledgment signal from the coherent interconnection bus being in the low-level state, the first acknowledgment signal that is in the low-level state; and
setting a second acknowledgment signal to the low-level state once the synchronization is done, so as to disconnect the first link; and
wherein disconnecting the second link between the coherent interconnection bus and the DTD circuit comprises:
setting a hint signal to a high-level state, the hint signal in the high-level state being used to instruct the coherent interconnection bus to set a third request signal to a low-level state;
synchronizing, in response to the third request signal from the coherent interconnection bus being in the low-level state, the third request signal that is in the low-level state;
setting a fourth request signal to the low-level state once the synchronization is done and a link disconnection request is received from the DTD circuit, the fourth request signal in the low-level state being used to instruct the DTD circuit to set a third acknowledgment signal to the low-level state;
synchronizing, in response to the third acknowledgment signal from the DTD circuit being in the low-level state, the third acknowledgment signal that is in the low-level state; and
setting a fourth acknowledgment signal to the low-level state once the synchronization is done, so as to disconnect the second link.
